(19) United States
(12) Patent Application Publication
(10) Pub. No.: US 2011/0279036 A1
(43) Pub. Date: Nov. 17, 2011

(54) Stabilized High Brightness LED suitable as calibration standard

(76) Inventors: Andrew Julius Muray, Portland, OR (US); Robin Lynn Teitzel, Portland, OR (US)

(21) Appl. No.: 12/780,652

(22) Filed: May 14, 2010

(51) Int. Cl. H05B 37/02

(52) U.S. Cl. 315/112

(57) ABSTRACT

A high brightness LED (102) is precisely controlled. The temperature of the LED (102) is controlled via controlled thermal resistance (300), measurement of the base temperature (302) and careful power monitoring of the LED (102).

### BACKGROUND OF INVENTION—FIELD OF INVENTION

This invention relates to the calibration standards, specifically for the High Brightness LED (HBLED). The unit provides a stabilized light output, both intensity and wavelength.

### BACKGROUND OF THE INVENTION—PRIOR ART

LED calibration standards today use an LED which uses 20 mA of current. An example of a calibration standard today is the Inphora xxx-xxx unit. This unit supplies about 20 mA at approximately 3V to the LED. A key attribute in a stable calibration standard is the temperature of the LED is controlled. In the Inphora xxx-xxx unit this is done by sensing the LED voltage. The LED voltage will change depending on temperature approximately −2 mV per degree C. This is fed back to the circuit to stabilize the temperature.

LEDs will change properties over time. Observations have been made where the voltage across the LED will increase over time, even though the temperature and current are controlled. The variation over time is likely due to changes in the optically active band gap of the semiconductor. Thus a feedback system using the LED voltage will vary the controlled temperature. The rate of change of this property varies on how long the LED has been in operation. One technique to minimize this effect is to age the LED until the rate of change is low enough to tolerate.

The Inphora xxx-xxx unit, the LED has a power dissipation of 60 mW. The low power dissipated is adequately cooled with the surrounding environment. Since the LED temperature is above ambient, heating is the main issue, not cooling. For HBLED units the power dissipation is 3.2 W or higher. Additional heating units would cause more power needed to be dissipated. Thus the cooling and dissipation of the heat would be a problem with the current scheme.

The LED junction is maintained at a higher temperature than the surrounding environment. Nominally 60 degrees C. is the target temperature in the Inphora xxx-xxx unit. By picking a temperature higher than ambient, only a heater is needed to control the temperature of the LED. The Inphora xxx-xxx unit currently has a heater, but not any need for heat removal given the low power dissipated.

### BACKGROUND OF INVENTION—OBJECTS AND ADVANTAGES

Several objects and advantages of the present invention are:

(a) High power LED drive, 920 mA at 3.2V

(b) Precise current control, 920 mA controlled to +/1 mA

(c) LED aging does not effect temperature control

(d) High power (approximately 3.2 W) heat is removed effectively from the LED to allow precise control of the temperature.

(e) Cooling of the LED and moving the heat to an outside radiator without increasing heat flow in the area of the LED

### SUMMARY

### Drawings—Figures

FIG. 1 is the front view of the HBLED

FIG. 2 is the side view of the HBLED

FIG. 3 shows the copper bar, the LED on the LED board, and the heater board.

FIG. 4 is the schematic of the control system, implementing the correction equation

### DRAWING—REFERENCE NUMBERS

100 LED board. The LED mounts to this board

102 LED

104 25 mm Aluminum tube

106 4-40 mounting screw

200 2 pin connector, supplies power to LED

202 Heater board

204 Power board, supplies LED power and Heater power

206 Control board

208 Copper bar

300 controlled thermal resistance feature in copper bar

302 mounting hole for thermistor to measure base temperature of copper bar

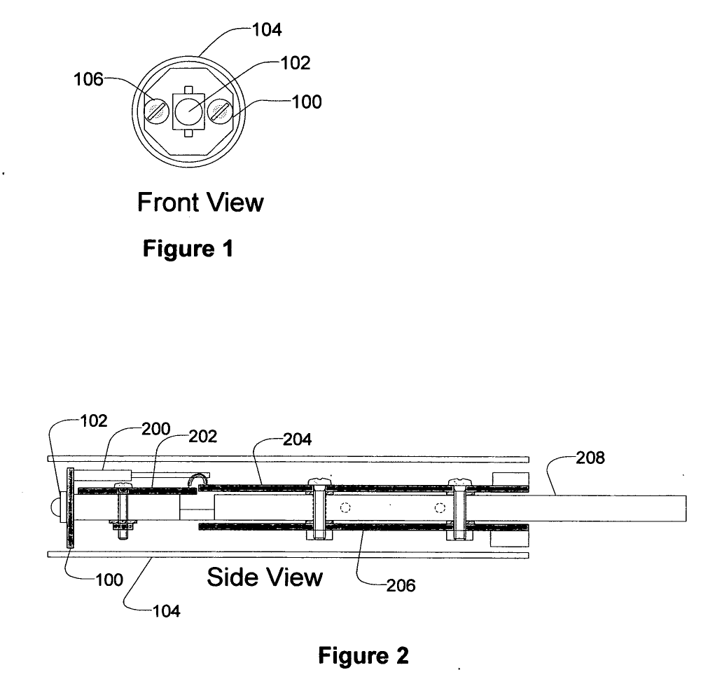

### DETAILED DESCRIPTION—FIGURES 1, 2, 3 AND 4 PREFERRED EMBODIMENT

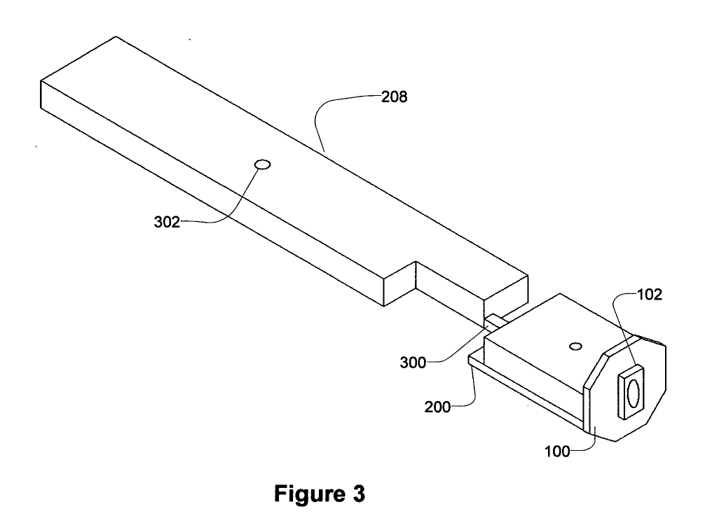

A preferred embodiment of the HBLED calibration standard is illustrated in FIG. 1, front view, FIG. 2 side view, and FIG. 3 a isometric view of the copper bar. A tube 106 with a diameter of 25 mm is used. The current calibration standards and test fixtures are designed fro 25 mm Outside Diameter (OD). The HBLED 102 is centered on a board 100. The board 100 is held to the copper bar 208 by plastic screws 104.

In the preferred embodiment the copper bar 208 is used. The bar could use other material such as Aluminum, but with increased thermal resistance.

In the preferred embodiment, a heater board 202 is used to generate heat and increased temperature. The board is composed of 8 1 ohm resistors in series. The Led board 100 is connected to the power board 204 using a 2 pin connector 200. The power board 204 provides 920 mA of current to the LED +/−2%. The power board 204 also provides the power to drive the heater board 202. The power board 204 is controlled by the control board 206. The copper bar 208 provides the thermal path way for cooling the system. Not shown is the heatsink at the end of the copper bar providing cooling to the environment.

The copper bar 208 has a feature 300 dimensions which are 0.1″×0.177″×0.328″ in the preferred embodiment. The feature 300 is a controlled thermal resistance of ˜4 degree C/W. This feature is calibrated to the amount of power dissipated by the combined LED 102 and heater board 202 to provide a controlled temperature based on the variation in room temperature through the heat sink.

The hole 302 is where a precision thermistor is placed to measure the temperature.

The mass of a copper used provides a nice damper on the system.

To control the temperature of the system, the power to the heater board 202 is controlled. The control is based on this equation:

Pheater=(Tset−Tcool)*K1+(Pset-Pled)*K2

Pheater is the power to the heater board 202. Tset is the desired temperature at the LED 102. Tset is set to be 20 to 30 degrees higher than the maximum temperature in the room of operation. In the preferred embodiment, Tset is 60 degrees C. Tcool is the temperature measured at the hole 302. Pset is the set to the maximum power the LED 102 will ever consume in any situation. The intent of (Pset-Pled) part of the equation is to cause the system to provide constant power through controlled thermal resistance feature 300. K1 is the coefficient needed to convert temperature to power. K1 is determined by the thermal resistance from the heater to the cooling base. K2 is the coefficient needed to convert the difference in power to the LED 102 and the maximum power. The coefficient is only a scaling factor and the thermal resistance does not come into play.

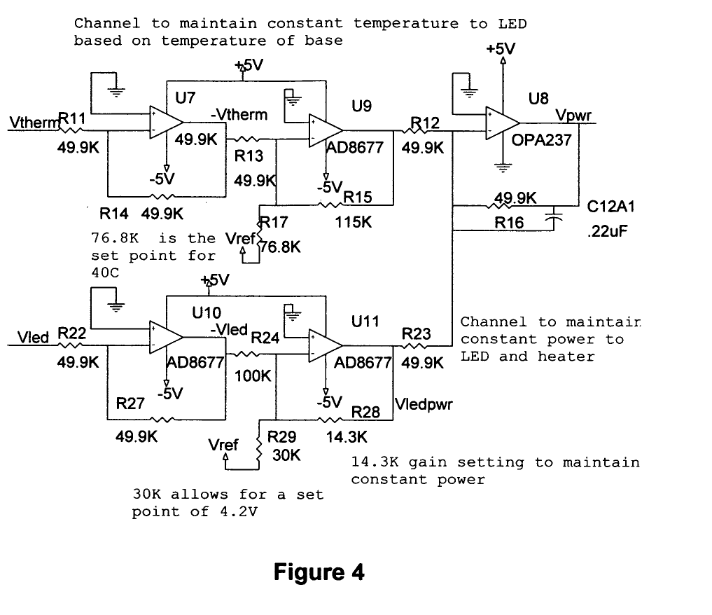

In the preferred embodiment, FIG. 4 is an electronic control used. The circuit implements the control as described in the above equation. The inputs are the voltage corresponding to the temperature at the hole 302 (Vtherm) and the voltage across the LED 102. The voltage across the LED 102 can be converted to the power knowing the current is set at 920 mA. The output voltage of the control system, Vpwr, varies between 0 V and 1.25 V. The maximum power of the heater board 202 is 8 W when Vpwr is 1.25 V.

### ADVANTAGES

From the description above, a number of advantages the stabilized HBLED system become evident:

(a) The aging of the LED does not change the operational points

(b) The power from the LED is removed from the area of the LED in a controlled manner

(c) The unit fits into a small 25 mm tube packaging allowing the continued use of current test systems.

(d) The control systems avoid temperature oscillations

(e) The control system is stable

### CONCLUSIONS, RAMIFICATIONS, AND SCOPE

Thus the reader will see that the stabilized HBLED unit provides a highly stabilized reliable high brightness LED useful as a laboratory standard. This invention allows the continued use of standard text fixtures with high power dissipation in the LED. Also the invention controls the temperature precisely allowing the LED to operate in a consistent manner.

Although the description above contains many specificities, these should not be construed as limiting the scope of the invention but merely providing illustration of some of the presently preferred embodiments of this invention. For example the control system could be implemented in a microprocessor. As another example the shape and size of the thermal resistance feature could be changed if the power consumed in the LED is changed. The size of the thermal resistance feature could be varied if the set point is changed, etc.

Thus the scope of the invention should be determined by the appended claims and their legal equivalents, rather than by the examples given.

We claim:

1. Described thermal control can be used for discrete or multiple LED lighting fixtures if accurate control of light intensity and color is required. (LED, HBLED).

2. Described thermal control system may be only way to accurately control very high brightness LEDs (VHBLED), where the optical power output is greater than 500 lumens.
